(19) United States
(12) Patent Application Publication
(10) Pub. No.: US 2007/0284408 A1
(43) Pub. Date: Dec. 13, 2007

(54) REFLOW FURNACE

(75) Inventors: Toshiyuki ASAI, Tokyo (JP); Motohiro Yamane, Tokyo (JP); Takayuki Matsuoka, Tokyo (JP); Atsushi Tanaka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TAMURA FURUKAWA MACHINERY CORPORATION, Sayama-shi (JP)

(21) Appl. No.: 11/755,328

(22) Filed: May 30, 2007

(30) Foreign Application Priority Data
Jun. 9, 2006 (JP) 2006-160591

(51) Int. Cl. B23K 1/012

(52) U.S. Cl. 228/42

(57) ABSTRACT

A reflow furnace comprises: carrier device to carry a printed circuit board with electronic components mounted thereon; a heating chamber to heat through an ambient gas the printed circuit board carried therein to solder the electronic components on a surface of the printed circuit board; and an ambient gas purification equipment including a retrieving device to retrieve a part of the ambient gas containing vaporized flux component when soldering, a heating device to heat the retrieved ambient gas to a desired temperature, an oxidation catalyst to burn the flux component contained in the heated ambient gas, a control device to control an oxygen concentration in a high temperature gas after being burned, and a returning device to return the high temperature gas with the oxygen concentration controlled after being burned to the heating chamber.

### BACKGROUND OF THE INVENTION

1. Technical Field

The present invention relates to a reflow furnace in which a printed circuit board mounting electronic components is soldered, in particular a reflow furnace including an ambient gas purification equipment in which the flux component vaporized during soldering and mixed in the ambient gas is effectively burn-treated.

2. Related Arts

Various electronic components are called as SMDs (Surface Mounted Devices), and are directly mounted on a surface of a printed circuit board and soldered. The soldering is performed with the use of a soldering paste. A cream flux and a particle solder are made paste to prepare the soldering paste. The soldering paste is applied to a portion to be soldered in the printed circuit board by printing, dispenser or the like, and then the electronic components are mounted thereon. The printed circuit board mounting electronic components with the soldering paste is then heated the reflow furnace to melt the soldering paste, thus soldering electronic components to the printed circuit board.

The flux in the soldering paste functions to remove an oxidized film on the metal surface to be soldered, to prevent the metal surface from being re-oxidized by heating during soldering, and to make small the surface tension of the soldering to improve wettability. Since the flux is made by melting the solid elements of pine resin, thixotropic agent, activator or the like with the use of solvent, those are vaporized when the soldering paste is heated and melted in the reflow furnace. The vaporized flux component contacts with a low temperature (up to about 110 Celsius degree) portion of the reflow furnace to be liquidated and attached onto the printed circuit board, thus deteriorating the solder, or thwarting the motion of the movable parts in the reflow furnace.

In order not to deteriorate the solder by the flux component attached onto the printed circuit board, there is proposed a flux collecting equipment in which the ambient gas including an inert gas is heated, and the flux component mixed in the ambient gas is cooled to be liquefied and collected.

The above described conventional collecting equipment is shown in FIG. 13. Electronic components are mounted the printed circuit board 10 which is carried ( in a direction vertical to the surface of the drawing) in the heating chamber 103 of the reflow furnace 101 by a carrier device 105. The fan motor 109 is arranged in the upper portion of the carrier device 105. The ambient gas 113 is caused by the fan 111 driven by the motor 109 to pass through the heaters 115 and to be blown onto the carried printed circuit board, thus heated and circulated. A by-pass route 117 is arranged to by-pass the above described circulation of the ambient gas, and the heat sink 119 which is one of the heat exchanger is arranged inside of the by-pass route 117. The ambient gas 113 guided through the by-pass route 117 is cooled by the heat exchange to the outside air, thus the flux component in the ambient gas 113 is liquefied. The flux liquefied on the surface of the heat sink 119 falls in drops into the tank 121 by gravity and is collected therein arranged below the heat sink 119. The ambient gas 123 with the liquefied flux removed is returned to the heating chamber 103.

The ambient gas may be suctioned by the fan separately installed and guided into the by-pass route 117.

There is proposed an ambient gas purification equipment in which the flux gas in the soldering ambient within the soldering equipment body is oxidized by the oxygen catalyst. Refer to Japanese Patent No. 3511396.

In the above described conventional technology in which the flux is liquefied and removed, since the ambient gas 123 returned to the heating chamber is already cooled by the heat sink 119, the remaining flux component not removed in the ambient gas is liquefied at the wall surface with a low temperature, and stuck thereto.

Furthermore, the circulating ambient gas 113 is cooled by the heat sink 119, thus it is necessary to reheat the ambient gas to a required temperature. Accordingly, the consumption power of the heater becomes large, which reverses the energy conservation.

In the conventional technology in which the flux gas is oxidized, since the flux is positively oxidized and decomposed by heating the ambient gas using inflammable materials, the temperature of the gas after the treatment becomes higher, it is necessary to have an additional treatment such as the cooling of the high temperature gas or the like, thus causing an energy loss.

The present invention has been made to solve the above described problems in the prior arts, and aims to provide a reflow furnace in which the flux component in the ambient gas is effectively burned, it is possible to control the temperature of the heating chamber without applying a specific cooling means, and it is possible to lower the heating amount in the heating chamber.

### SUMMARY OF THE INVENTION

Inventors have intensively studied to solve the above described problems. As a result, it has been found that the oxygen concentration in the furnace can be stabled if the oxygen concentration in the ambient gas returning from the purification equipment to the furnace after burn-treatment is controlled in the reflow furnace having the purification equipment including oxygen catalyst.

More specifically, it has been found that the temperature of the heating chamber can be effectively controlled without applying the high temperature gas cooling means, by the following steps: retrieving a part of the ambient gas containing the flux component vaporized during soldering in the ambient gas purification equipment attached to the reflow furnace, heating the thus retrieved ambient gas to a desired temperature, burning the flux component contained in the heated ambient gas by the oxygen catalyst, then controlling the oxygen concentration of the high temperature gas after burn-treatment with the oxygen consumed by the burning, and returning the high temperature gas with the oxygen concentration thus controlled to the heating chamber so that the oxygen consumed by the burning is controlled to be identical to the oxygen concentration in the furnace.

A first embodiment of the reflow furnace of the invention comprises: a carrier device to carry a printed circuit board with electronic components mounted thereon;
a heating chamber to heat through an ambient gas the printed circuit board carried therein to solder the electronic components on a surface of the printed circuit board; and
an ambient gas purification equipment including a retrieving device to retrieve a part of the ambient gas containing vaporized flux component when soldering, a heating device to heat the retrieved ambient gas to a desired temperature, an oxidation catalyst to burn the flux component contained in the heated ambient gas, a control device to control an oxygen concentration in a high temperature gas after being burned, and a returning device to return the high temperature gas with the oxygen concentration controlled after being burned to the heating chamber.

In a second embodiment of the reflow furnace of the invention, the control device to control the oxygen concentration in the high temperature gas includes an oxygen supply device, an oxygen consumption detecting device, a computing device to calculate an oxygen supply quantity from the oxygen concentration in the heating chamber and the detected oxygen consumption, and wherein an oxygen is supplied according to the calculated oxygen supply quantity to control the oxygen concentration of the high temperature gas after being burned to correspond to the oxygen concentration in the heating chamber.

A third embodiment of the reflow furnace of the invention further comprises a measuring device to measure the oxygen concentration within the heating chamber, and wherein said computing device calculates the oxygen supply quantity from a difference in the heating chamber between a preset oxygen concentration and an oxygen concentration measured by the measuring device, as well as the detected oxygen consumption.

In a fourth embodiment of the reflow furnace of the invention, said computing device calculates the oxygen supply quantity from a difference between a preset oxygen concentration in the heating chamber and an oxygen concentration measured by the oxygen consumption detecting device.

In a fifth embodiment of the reflow furnace of the invention, said computing device calculates the oxygen supply quantity from a difference between a measured carbon dioxide concentration in the heating chamber and a carbon dioxide concentration measured by the oxygen consumption detecting device.

In a sixth embodiment of the reflow furnace of the invention, said computing device calculates the oxygen supply quantity from a difference between a preset oxygen concentration in the heating chamber and the oxygen concentration calculated by the difference between the ambient gas temperatures measured by the oxygen consumption detecting device before and after the oxidation catalyst.

In a seventh embodiment of the reflow furnace of the invention, said retrieving device includes a retrieving port from which the part of the ambient gas is retrieved, said returning device includes a returning port through which the high temperature gas is returned, and said ambient gas purification equipment includes a circulatory pathway which circulates from the retrieving port to the returning port.

In an eighth embodiment of the reflow furnace of the invention, the oxygen supply device and the oxygen consumption detecting device are installed in a vicinity of the returning port, and an oxygen supply route of the oxygen supply device is installed upstream side of the oxygen consumption detecting device.

In a ninth embodiment of the reflow furnace of the invention, the oxygen supply device is installed in a vicinity of the retrieving port in the circulatory pathway, and the oxygen consumption detecting device is installed in a vicinity of the returning port in the circulatory pathway.

In a tenth embodiment of the reflow furnace of the invention, the oxygen supply device is installed in a vicinity of the retrieving port in the circulatory pathway.

In an eleventh embodiment of the reflow furnace of the invention, the retrieving port and the returning port are installed in at least one heating zones.

In a twelfth embodiment of the reflow furnace of the invention, said ambient gas purification equipment is externally fixed in a reflow furnace body including heating chamber having the carrier device installed inside thereof.

In a thirteenth embodiment of the reflow furnace of the invention, the retrieving device includes a flow rate control device to control the ambient gas to be retrieved.

### BRIEF DESCRIPTION OF THE DRAWINGS

FIG. 1 is an overall view showing a reflow furnace according to one embodiment of the present invention;

FIG. 2A is a sectional view of FIG. 1, FIG. 2B is an essential portion of an enlarged view of FIG. 2A;

FIG. 3 is a view explaining one embodiment of the ambient gas purification equipment of the invention;

FIG. 4 is a view explaining one of other embodiments of the ambient gas purification equipment of the invention;

FIG. 5 is a view explaining one of other embodiments of the ambient gas purification equipment of the invention;

FIG. 6 shows a part of the reflow furnace with the ambient gas purification equipment of one embodiment of the invention externally attached to the upper portion of the heating chamber;

FIG. 7 is a view explaining one of other embodiments of the ambient gas purification equipment of the invention;

FIG. 8 is a graph showing correlation between the ambient gas temperature and the oxygen concentration before and after passing the catalyst;

FIG. 9 shows a graph representing variation of the oxygen concentration in the ambient gas purification equipment and the oxygen concentration in the furnace;

FIG. 10 is a view explaining one of other embodiments of the ambient gas purification equipment of the invention;

FIG. 11 is a view explaining one of other embodiments of the ambient gas purification equipment of the invention;

FIG. 12 is a view explaining one of other embodiments of the ambient gas purification equipment of the invention; and

FIG. 13 shows a cross sectional view of the conventional collecting equipment.

### DETAILED DESCRIPTION OF THE INVENTION

The embodiments of the reflow furnace of the present invention are described with reference to the accompanying drawings.

One of the embodiments of the reflow furnace of the invention comprises: a carrier device to carry a printed circuit board with electronic components mounted thereon; a heating chamber to heat through an ambient gas the printed circuit board carried therein to solder the electronic components on a surface of the printed circuit board; and an ambient gas purification equipment including a retrieving device to retrieve a part of the ambient gas containing vaporized flux component when soldering, a heating device to heat the retrieved ambient gas to a desired temperature, an oxidation catalyst to burn the flux component contained in the heated ambient gas, a control device to control an oxygen concentration in a high temperature gas after being burned, and a returning device to return the high temperature gas with the oxygen concentration controlled after being burned to the heating chamber.

The above-mentioned ambient gas purification equipment may be externally fixed in a reflow furnace body including heating chamber having the carrier device installed inside thereof. In addition, the retrieving device may include a flow rate control device to control the ambient gas to be retrieved.

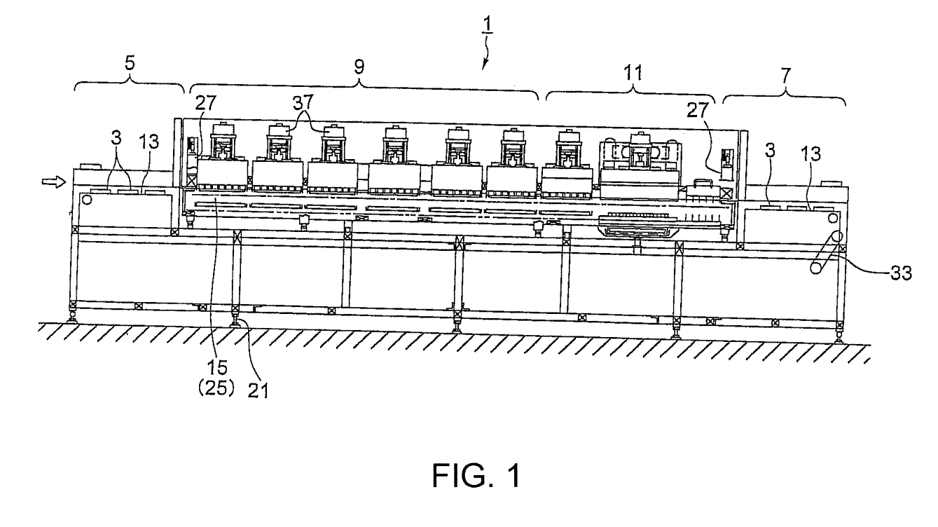

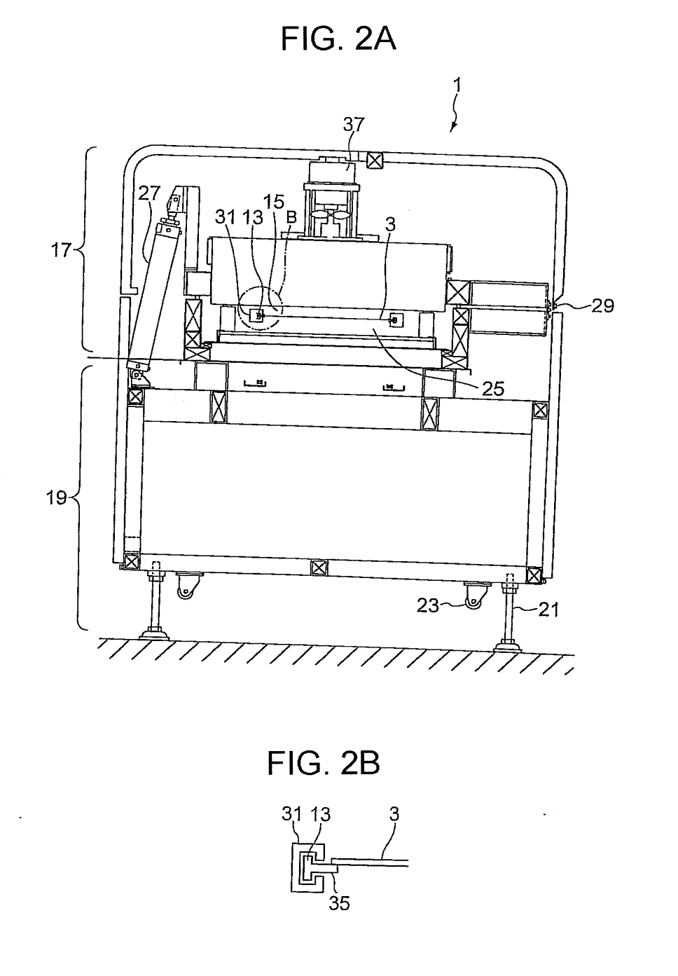

At first the entirety of the reflow furnace of the invention is described. The reflow furnace 1, as shown in the overall view of FIG. 1, and the cross sectional view of FIG. 2A, has an overall configuration of extending in a horizontal direction. A plurality of printed circuit boards 3 are carried in from an inlet portion 5 on the left of the drawing and carried out of an outlet portion 7 on the right of the drawing. There is arranged a heating chamber 9 heating the printed circuit boards 3 at the center of the reflow furnace along the longitudinal direction, and a cooling chamber 11 cooling the heated printed circuit boards 3 at the end thereof along the longitudinal direction.

A long heating chamber 15 is formed along a horizontal direction so as to surround a chain conveyer 13 which is a carrier device to carry the printed circuit boards in a horizontal direction. The heating chamber 15 is arranged between a removable upper structure 17 and a lower structure 19.

The lower structure 19 has at a lower face thereof a foot portion 21 which is extendable, and a wheel 23 for movement, and at the center of the upper face a recessed portion 25 which forms the heating chamber. In addition, one end of a cylinder 27 is attached to the lower structure, which opens and closes the upper structure 17.

The upper structure 17 is rotationally fixed to the lower structure 19 around a rotational axis 29, which is arranged in parallel to the carrying direction so as to cover the recessed portion 25 of the lower structure 19 in such a manner as a roof which opens and closes. The other end of the cylinder 27 is fixed to the upper structure 17 to open and close the upper structure.

A pair of the chain conveyers 13 are arranged in the lower portion of the heating chamber 15 in a carrying direction, and guided by the respective guide rails 31. The chain conveyers 13 are driven by a drive sprocket mechanism 33. The printed circuit boards 3 are carried with both side ends supported. To support the printed circuit boards, a supporting protrusion 35 is formed inside of the respective chain conveyers 13 (refer to FIG. 2B).

A plurality of hot air fan motors 37 are arranged in the upper portion of the heating chamber 9 (15) along the longitudinal direction. The ambient gas 41 is circulated by the rotating fans 39 such as a turbofan or sirocco fan.

The control device to control the oxygen concentration in the high temperature gas includes an oxygen supply device, an oxygen consumption detecting device, a computing device to calculate an oxygen supply quantity from the oxygen concentration in the heating chamber and the detected oxygen consumption, and wherein an oxygen is supplied according to the calculated oxygen supply quantity to control the oxygen concentration of the high temperature gas after being burned to correspond to the oxygen concentration in the heating chamber. A preset oxygen concentration or a measured oxygen concentration is used as the oxygen concentration in the heating chamber.

An oxygen concentration meter, carbon dioxide concentration meter, thermometer before and after passing the oxidation catalyst or the like may be used as the oxygen consumption detecting device. An oxygen (air) supply route is used as the oxygen supply device. An integrator, controller or the like is used as the computing device to calculate oxygen supply quantity from the oxygen concentration in the heating chamber and the detected oxygen consumption.

FIG. 9 shows a graph representing variation of the oxygen concentration in the ambient gas purification equipment and the oxygen-concentration in the furnace. As shown in FIG. 9, the oxygen concentration in the furnace is lowered beyond the manageable limit, when the ambient gas is returned without controlling the oxygen concentration in the ambient gas purification equipment.

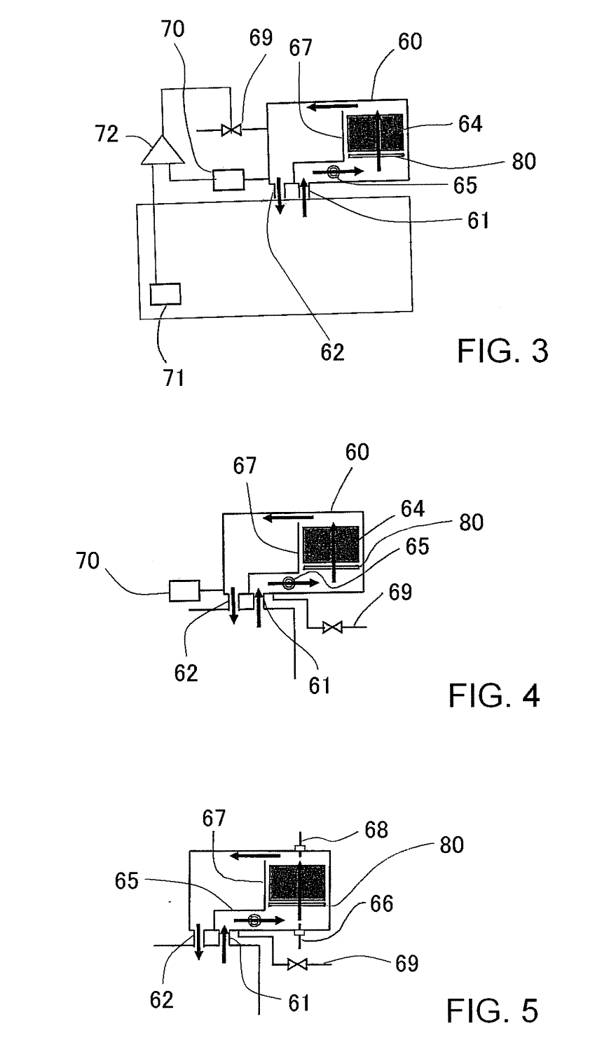

FIG. 3 shows one embodiment of the ambient gas purification equipment of the invention. As shown in FIG. 3, the ambient gas purification equipment 60 includes a retrieving port 61 to retrieve a part of the ambient gas from the furnace, a returning port 62 through which a high temperature gas is returned to the furnace, and a circulatory pathway in which the part of the ambient gas circulates from the retrieving port 61 to the returning port 62. A heater 65 for controlling a temperature of the catalyst, the oxygen catalyst 64 are arranged on the way in the circulatory pathway, and in addition, an oxygen (air) supply route 69 and oxygen concentration meter 70 to measure the oxygen concentration are arranged nearby the retuning port 62. Furthermore, a partition wall 67 to separate an outward route and a homeward route is arranged in the circulatory pathway. In addition, an oxygen concentration meter 71 to measure the oxygen concentration in the heating chamber is arranged in the furnace. A filter may be arranged at the upstream side of the oxygen catalyst 64. When the filter is thus arranged, the substance to deteriorate the catalyst such as Si (Silicon) compound can be removed to realize a longer operating life of the catalyst.

The part of the ambient gas retrieved though the retrieving port is heated to a desired temperature by a heating means (for example, a heater) for controlling the catalyst temperature and passes through the oxygen catalyst with the catalyst temperature of 300 to 400 Celsius degree so that the flux component contained in the ambient gas is subjected to the oxidation treatment to be decomposed into water and carbon dioxide. The oxygen concentration of the high temperature gas thus subjected to the oxidation treatment is measured by the oxygen concentration meter 70. On the other hand, the oxygen concentration in the furnace is measured by the oxygen concentration meter 71.

In general, the oxygen is consumed by the above-mentioned burning of the ambient gas in the ambient gas purification equipment to cause a difference from the measured oxygen concentration in the furnace. The oxygen amount to be added is calculated from the difference between the oxygen concentration in the furnace measured by the computing device 72 and the oxygen concentration in the ambient gas. The oxygen amount thus calculated is supplied through the oxygen (air) supply route so that the oxygen concentration in the ambient gas becomes identical to the oxygen concentration in the furnace. Thus, the oxygen concentration in the high temperature gas passing through the returning port 62 is controlled, and the high temperature gas is returned through the returning port 62 to the heating chamber.

In this embodiment, the oxygen (air) supply route is arranged at the upstream side of the oxygen concentration as described above. Incidentally, the retrieving device to retrieve the part of the ambient gas may include a flow rate control device to control the ambient gas to be retrieved.

FIG. 4 shows another embodiment of the ambient gas purification equipment of the invention. The ambient gas purification equipment 60 of this embodiment includes a retrieving port 61 to retrieve a part of the ambient gas from the furnace, a returning port 62 through which a high temperature gas is returned to the furnace, and a circulatory pathway in which the part of the ambient gas circulates from the retrieving port 61 to the returning port 62, in the same manner as the embodiment described with reference to FIG. 3. The ambient gas purification equipment of the embodiment as shown in FIG. 4 includes a heater 65 for controlling the catalyst temperature, an oxygen catalyst 64, and a partition wall 67 to separate an outward route and a homeward route respectively on the way in the circulatory pathway, and in addition, an air supply route 69 to supply the oxygen (air) in the vicinity of the retrieving port 61, as well as an oxygen concentration meter 70 to measure the oxygen concentration nearby the retuning port 62. Incidentally, a filter 80 may be arranged at the upstream side of the oxygen catalyst 64. When the filter 80 is thus arranged, the substance to deteriorate the catalyst such as Si (Silicon) compound can be removed to realize a longer operating life of the catalyst.

The oxygen (air) is supplied to the part of the ambient gas retrieved though the retrieving port, and the part of the ambient gas is heated by the heating device (for example, a heater) 65 for controlling the catalyst temperature to a desired temperature, and passes through the oxygen catalyst with the catalyst temperature of 300 to 400 Celsius degree so that the flux component contained in the ambient gas is subjected to the oxidation treatment to be decomposed into water (vapor) and carbon dioxide. In the embodiment as shown in FIG. 4, since the oxygen is supplied to the ambient gas, the ambient passing the catalyst becomes oxygen-rich, thus improving the effect of the flux treatment. In this embodiment, also the oxygen concentration of the high temperature gas thus subjected to the oxidation treatment is measured by the oxygen concentration meter 70. Air flow rate to be supplied through the air supply route is controlled by the difference between the preset oxygen concentration in the furnace and the measured oxygen concentration so that the preset oxygen concentration becomes identical to the measured oxygen concentration.

FIG. 5 shows another embodiment of the ambient gas purification equipment of the invention. In the embodiment as shown in FIG. 5, the ambient gas purification equipment 60 includes a retrieving port 61 to retrieve a part of the ambient gas from the furnace, a returning port 62 through which a high temperature gas is returned to the furnace, and a circulatory pathway in which the part of the ambient gas circulates from the retrieving port 61 to the returning port 62, in the same manner as the embodiment described with reference to FIG. 4. The ambient gas purification equipment includes an air supply route 69 to supply the oxygen (air), heater 65 for controlling the catalyst temperature in the vicinity of the retrieving port 61a, as well as an oxygen catalyst 64, a thermometer 66 to measure the temperature of the ambient gas before the oxygen catalyst, a thermometer 68 to measure the temperature of the ambient gas after passing the oxygen catalyst and a partition wall 67 to separate an outward route and a homeward route respectively on the way in the circulatory pathway. Incidentally, a filter 80 may be arranged at the upstream side of the oxygen catalyst 64. When the filter 80 is thus arranged, the substance to deteriorate the catalyst such as Si (Silicon) compound can be removed to realize a longer operating life of the catalyst.

In the embodiment as shown in FIG. 5, the temperatures of the ambient gas before and after passing the catalyst are respectively measured, and the oxygen consumption is calculated from the temperature difference. The same amount of the oxygen is supplied through the oxygen supply route as the calculated amount of the oxygen to control the oxygen concentration of the high temperature gas returning through the returning port 62 to the heating chamber. According to this embodiment, since the amount of the generated heat is estimated to be the oxygen consumption, the oxygen to be supplied is controlled by the increased temperature. Since the thermometer quickly responds, the control of the oxygen to be supplied can be timely effected.

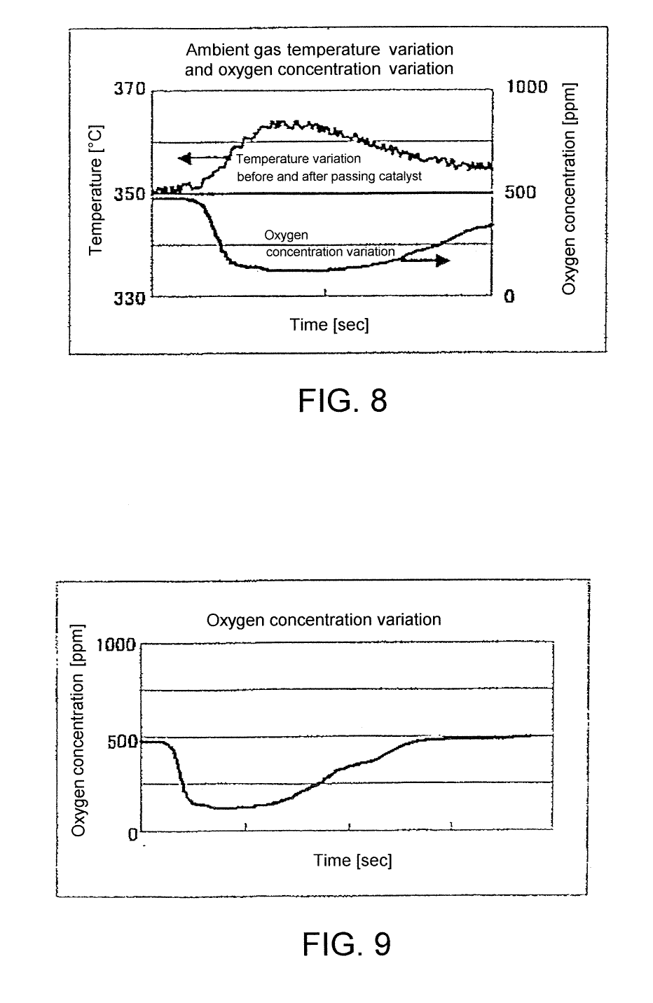

FIG. 8 is a graph showing correlation between the ambient gas temperature and the oxygen concentration before and after passing the catalyst. In FIG. 8, the vertical axes represent the temperature [Celsius degree], and the oxygen concentration [ppm], and the horizontal axis represents the time [sec]. As shown in the graph, the temperature variation after passing the catalyst corresponds to the oxygen concentration variation in connection with the temperature of 350 Celsius degree before passing the catalyst. More specifically, the temperature rises in response to the lowering of the oxygen concentration, whereas the temperature lowers in response to the rising of the oxygen concentration. Thus, there exists a sure correlation between the ambient gas temperature and the oxygen concentration before and after passing the catalyst.

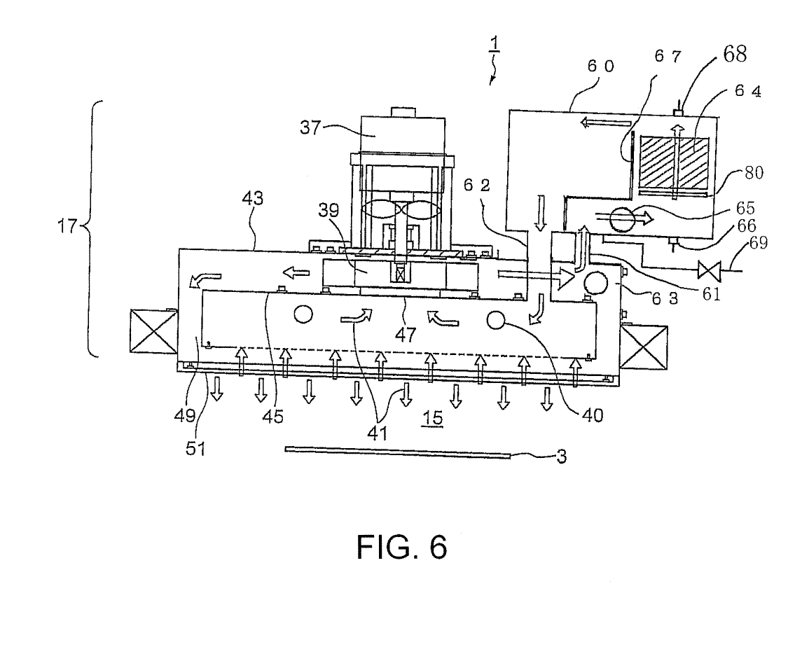

FIG. 6 shows a part of the reflow furnace with the ambient gas purification equipment of one embodiment of the invention externally attached to the upper portion of the heating chamber. The ambient gas purification equipment 60 shown in FIG. 6 is substantially the same ambient gas purification equipment as that shown in FIG. 5, where the retrieving port 61 and the returning port 62 of the ambient gas are arranged in one zone. The ambient gas is returned through the returning port to the heating chamber. More specifically, the ambient gas purification equipment 60 includes a retrieving port 61 to retrieve a part of the ambient gas from the furnace, a returning port 62 through which a high temperature gas is returned to the furnace, and a circulatory pathway in which the part of the ambient gas circulates from the retrieving port 61 to the returning port 62. The ambient gas purification equipment 60 includes an air supply route 69 to supply the oxygen (air), heater 65 for controlling the catalyst temperature, an oxygen catalyst 64, a thermometer 66 to measure the temperature of the ambient gas before the oxygen catalyst, a thermometer 68 to measure the temperature of the ambient gas after passing the oxygen catalyst and a partition wall 67 to separate an outward route and a homeward route respectively on the way in the circulatory pathway.

Incidentally, a filter may be arranged at the upstream side of the oxygen catalyst 64. When the filter 80 is thus arranged, the substance to deteriorate the catalyst such as Si (Silicon) compound can be removed to realize a longer operating life of the catalyst.

As shown in FIG. 6, the upper portion of the heating chamber 15, which has a box-like structure opening downward, includes a double structure comprising an exterior plate 43 and a partition plate 45. A fan 39 is installed on the outside of the partition plate 45, which suctions the heated ambient gas by the heater 40 through the suction window 47 to the outside, and blows down the heated ambient gas through the outer periphery 49. The ambient gas thus blown hits the mesh body 51 arranged across the opening face of the lower portion of the box-like structure. Then, the ambient gas passes through the mesh and is uniformly blown onto the printed circuit board 3.

As shown in FIG. 6, the ambient gas purification equipment 60 is attached to the upper structure 17 forming the upper portion of the heating chamber 15. More specifically, a part of the outside of the double structure of the upper portion of the heating chamber is connected to the retrieving port 61 for retrieving the ambient gas to the ambient gas purification equipment 60. The retrieve port may include a control device to control the flow rate of the ambient gas.

The above described ambient gas purification equipment may be arranged in the respective zone of the plurality of zones. In this case, the oxygen concentration may be separately controlled in each zone. Furthermore, a high temperature exhaust heat may be used.

The control method of the oxygen concentration as shown in FIGS. 3 and 4 may be applied thereto.

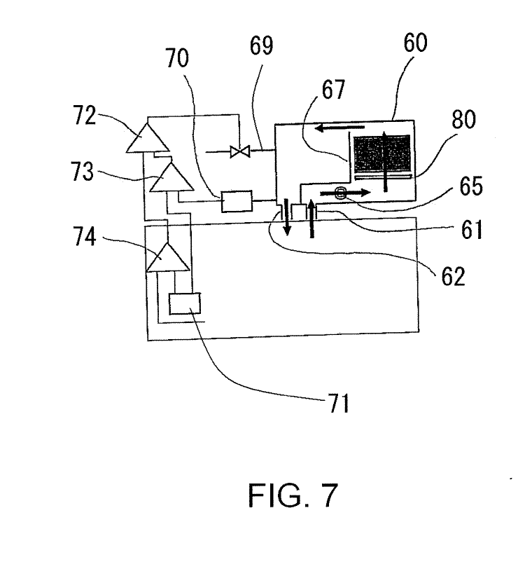

FIG. 7 shows another embodiment of the ambient gas purification equipment of the invention. The embodiment as shown in FIG. 7 positively control the oxygen concentration in the furnace. In particular, in addition to the stable control in the stationary state of the furnace, the oxygen concentration in case of the nonstationary state is positively controlled to be back to the stationary state. More specifically, the ambient gas purification equipment 60 includes a retrieving port 61 to retrieve a part of the ambient gas from the furnace, a returning port 62 through which a high temperature gas is returned to the furnace, and a circulatory pathway in which the part of the ambient gas circulates from the retrieving port 61 to the returning port 62, in the same manner as the embodiment described with reference to FIG. 3. The ambient gas purification equipment includes a heater 65 for controlling the catalyst temperature, an oxygen catalyst 64, a partition wall 67 to separate an outward route and a homeward route, an air supply route 69 to supply the oxygen (air), and an oxygen concentration meter 70 to measure the oxygen concentration on the way in the circulatory pathway. In addition, the oxygen concentration meter 71 in the furnace is arranged in the furnace to measure the oxygen concentration in the heating chamber. Incidentally, a filter may be arranged at the upstream side of the oxygen catalyst 64, in the same manner as described in other embodiments.

The part of the ambient gas is heated by the heating device (for example, a heater) for controlling the catalyst temperature to a desired temperature, and passes through the oxygen catalyst with the catalyst temperature of 300 to 400 Celsius degree so that the flux component contained in the ambient gas is subjected to the oxidation treatment to be decomposed into water (vapor) and carbon dioxide. The oxygen concentration of the high temperature gas thus subjected to the oxidation treatment is measured by the oxygen concentration meter 70. On the other hand, the oxygen concentration in the furnace is measured by the oxygen concentration meter in the furnace. The difference between the preset oxygen concentration in the furnace and the measured oxygen concentration in the furnace is calculated.

The ambient gas in the ambient gas purification equipment is burned by the catalyst to consume the oxygen so that the difference occurs between the preset oxygen concentration in the furnace and the measured oxygen concentration in the furnace. On the other hand, the difference occurs between the oxygen concentration in the ambient gas purification equipment and the measured oxygen concentration in the furnace. The computing device 74 calculates the difference between the preset oxygen concentration in the furnace and the measured oxygen concentration in the furnace. Furthermore, the computing device 73 calculates the difference between the measured oxygen concentration in the furnace and the measured oxygen concentration in the ambient gas purification equipment. The computing device 72 calculates the difference between the two differences between the preset oxygen concentration in the furnace and the measured oxygen concentration in the furnace, and between the measured oxygen concentration in the furnace and the measured oxygen concentration in the ambient gas purification equipment so as to obtain the oxygen amount to be added. The oxygen (air) is supplied through the oxygen (air) supply route until reaching the condition that the oxygen concentration in the ambient gas becomes identical to the preset oxygen concentration in the furnace, thus the oxygen concentration in the high temperature gas passing the returning port 62 to the furnace is controlled, and then thus controlled high temperature gas is returned to the heating chamber through the returning port 62.

As described above, by obtaining the two differences between the preset oxygen concentration in the furnace and the measured oxygen concentration in the furnace, and between the measured oxygen concentration in the furnace and the measured oxygen concentration in the ambient gas purification equipment, the oxygen concentration may be positively controlled to be stationary state even if the furnace becomes in nonstationary state.

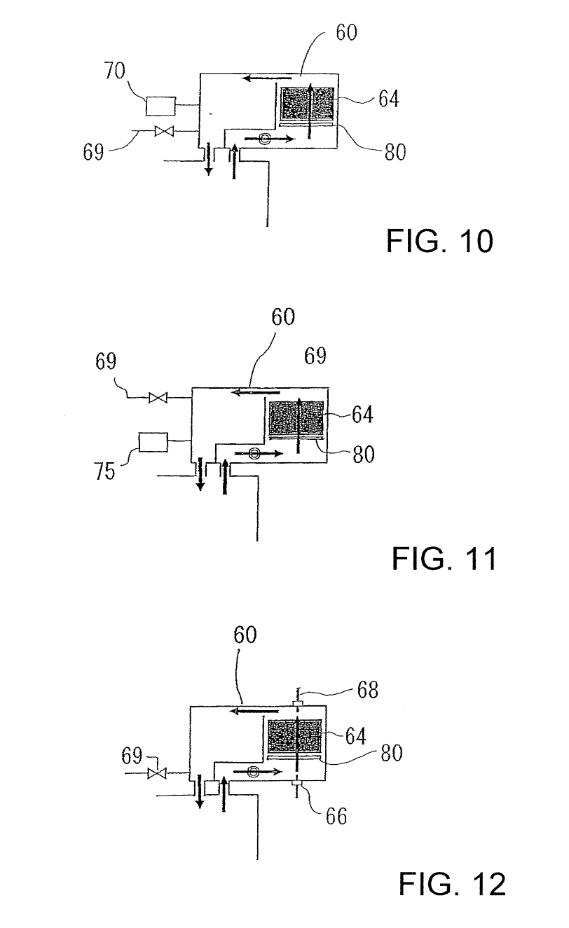

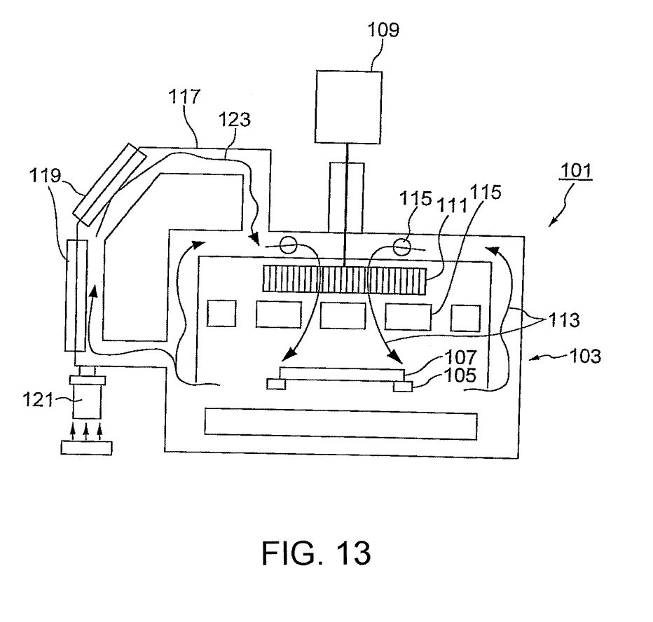

FIGS. 10 to 12 respectively show one of other embodiments of the ambient gas purification equipment of the invention. The embodiment as shown in FIG. 10 is the same embodiment as shown in FIG. 4 except that the oxygen concentration meter and the air supply route are arranged together in the side of the ambient gas returning port, and that the oxygen concentration meter is arranged at upstream side of the air supply route. The filter may be arranged at upstream side of the oxygen catalyst 64 in the same manner as those described in other embodiments. The embodiment as shown in FIG. 11 is the same embodiment as shown in FIG. 4 except that the carbon dioxide concentration is measured in place of the oxygen concentration, that the air supply route is arranged in the side of the ambient gas returning port, and that the air supply route is arranged at upstream side of the carbon dioxide concentration meter. The filter may be arranged at upstream side of the oxygen catalyst 64 in the same manner as those described in other embodiments. The embodiment as shown in FIG. 12 is the same embodiment as shown in FIG. 5 except that the air supply route is arranged in the side of the ambient gas returning port. The filter may be arranged at upstream side of the oxygen catalyst 64 in the same manner as those described in other embodiments.

In the present invention, the ambient gas in the furnace is retrieved and the flux in the ambient gas is burn-treated at the temperature of high efficiency catalyst burning. Since the oxygen is consumed by burning, the difference occurs between the oxygen concentration in the furnace and the oxygen concentration in the retrieved, burned and treated ambient gas. In order to control the difference between the oxygen concentrations, the separately controllable oxygen (air) supply device is arranged in the ambient gas purification equipment so that the oxygen concentration returning to the furnace is controlled to be identical to the oxygen concentration in the furnace. More specifically, since the oxygen concentration of the ambient gas, in which the ambient gas is burn-treated to consume the oxygen by the oxygen catalyst in the ambient gas purification equipment, is controlled upon returning from the ambient gas purification equipment to the furnace, the reflow furnace can be operated without disordering the oxygen concentration in the furnace.

According to the present invention, the controllability of the ambient gas in the reflow furnace is excellent, since the oxygen concentration may be controlled only by the retrieved ambient gas. In addition, the difference between the preset oxygen concentration and measured oxygen concentration both in the furnace is calculated, and the oxygen concentration of the retrieved ambient gas is controlled so that the oxygen concentration in the furnace can be positively controlled.

Accordingly, a reflow furnace can be provided in which the flux component is effectively burned in the ambient gas, and the temperature in the heating chamber can be controlled without applying specific cooling device to lower heating amount in the heating chamber.

Furthermore, in case that the oxygen concentration meter is arranged at downstream side of the catalyst, the flux concentration is low, so that the oxygen concentration meter is connected directly to the furnace body, thus shortening the time-lag. The oxygen concentration meter is hardly out of order.

What is claimed is:

1. A reflow furnace comprising:
a carrier device to carry a printed circuit board with electronic components mounted thereon;
a heating chamber to heat through an ambient gas the printed circuit board carried therein to solder the electronic components on a surface of the printed circuit board; and
an ambient gas purification equipment including a retrieving device to retrieve a part of the ambient gas containing vaporized flux component when soldering, a heating device to heat the retrieved ambient gas to a desired temperature, an oxidation catalyst to burn the flux component contained in the heated ambient gas, a control device to control an oxygen concentration in a high temperature gas after being burned, and a returning device to return the high temperature gas with the oxygen concentration controlled after being burned to the heating chamber.

2. The reflow furnace according to claim 1, wherein the control device to control the oxygen concentration in the high temperature gas includes an oxygen supply device, an oxygen consumption detecting device, a computing device to calculate an oxygen supply quantity from the oxygen concentration in the heating chamber and the detected oxygen consumption, and wherein an oxygen is supplied according to the calculated oxygen supply quantity to control the oxygen concentration of the high temperature gas after being burned to correspond to the oxygen concentration in the heating chamber.

3. The reflow furnace according to claim 2, which further comprises a measuring device to measure the oxygen concentration within the heating chamber, and wherein said computing device calculates the oxygen supply quantity from a difference in the heating chamber between a preset oxygen concentration and an oxygen concentration measured by the measuring device, as well as the detected oxygen consumption.

4. The reflow furnace according to claim 2, wherein said computing device calculates the oxygen supply quantity from a difference between a preset oxygen concentration in the heating chamber and an oxygen concentration measured by the oxygen consumption detecting device.

5. The reflow furnace according to claim 2, wherein said computing device calculates the oxygen supply quantity from a difference between a measured carbon dioxide concentration in the heating chamber and a carbon dioxide concentration measured by the oxygen consumption detecting device.

6. The reflow furnace according to claim 2, wherein said computing device calculates the oxygen supply quantity from a difference between a preset oxygen concentration in the heating chamber and the oxygen concentration calculated by the difference between the ambient gas temperatures measured by the oxygen consumption detecting device before and after the oxidation catalyst.

7. The reflow furnace according to claim 1, wherein said retrieving device includes a retrieving port from which the part of the ambient gas is retrieved, said returning device includes a returning port through which the high temperature gas is returned, and said ambient gas purification equipment includes a circulatory pathway which circulates from the retrieving port to the returning port.

8. The reflow furnace according to claim 7, wherein the oxygen supply device and the oxygen consumption detecting device are installed in a vicinity of the returning port, and an oxygen supply route of the oxygen supply device is installed upstream side of the oxygen consumption detecting device.

9. The reflow furnace according to claim 7, wherein the oxygen supply device is installed in a vicinity of the retrieving port in the circulatory pathway, and the oxygen consumption detecting device is installed in a vicinity of the returning port in the circulatory pathway.

10. The reflow furnace according to claim 7, wherein the oxygen supply device is installed in a vicinity of the retrieving port in the circulatory pathway.

11. The reflow furnace according to anyone of claims 7 to 10, wherein the retrieving port and the returning port are installed in at least one heating zones.

12. The reflow furnace according to claim 11, wherein said ambient gas purification equipment is externally fixed in a reflow furnace body including heating chamber having the carrier device installed inside thereof.

13. The reflow furnace according to claim 11, wherein the retrieving device includes a flow rate control device to control the ambient gas to be retrieved.
